(19) United States
(12) Patent Application Publication
(10) Pub. No.: US 2013/0093217 A1
(43) Pub. Date: Apr. 18, 2013

(54) MOTOR VEHICLE

(71) Applicant: GM GLOBAL TECHNOLOGY OPERATIONS LLC, Detroit, MI (US)

(72) Inventors: Udo MILDNER, Limburg (DE); Lothar TESKE, Aschaffenburg (DE)

(73) Assignee: GM GLOBAL TECHNOLOGY OPERATIONS LLC, Detroit, MI (US)

(21) Appl. No.: 13/649,394

(22) Filed: Oct. 11, 2012

(30) Foreign Application Priority Data
Oct. 11, 2011 (DE) 10 2011 115 796.8

(51) Int. Cl. B62D 25/08

(52) U.S. Cl. CPC B62D 25/088
USPC 296/203.04

(57) ABSTRACT

In a motor vehicle, in particular an automobile, with a rear underbody structure is provided. The motor vehicle includes as base and two longitudinal beams, spaced apart from one another, connected with a transverse beam at least in the front and rear region. The motor vehicle includes spring plates for supporting spiral springs. At least the transverse beam arranged in the rear region of the underbody structure is constructed as a hollow profile, a covering wall of which is formed from at least two individual carrier profiles which are connected with one another.

### CROSS-REFERENCE TO RELATED APPLICATION

This application claims priority to German Patent Application No. 10 2011 115 796.8, filed Oct. 11, 2011, which is incorporated herein by reference in its entirety.

### TECHNICAL FIELD

The present disclosure relates to a motor vehicle, in particular an automobile, with a rear underbody structure, which has a base and two longitudinal beams, spaced apart from one another, connected with a transverse beam at least in the front and rear region, and spring plates to support spiral springs.

### BACKGROUND

From the German patent application DE 10 022 916 open to public inspection, a motor vehicle with an undercarriage is known, which has a transverse beam, which has the shape of an upwardly open U profile in cross-section. The legs of the U profile, serving as side walls of the transverse beam, are provided at their free ends with weld flanges, at which the transverse beam is welded with the floor plate of the undercarriage. A spring seat region is provided in each case at the frontal ends of the transverse beams, on which spring seat region in each case a spring plate is fastened for receiving a helical spring. The helical spring serves here to support a rear axle unit against the transverse beam.

Accordingly, it is desirable to provide a motor vehicle, in particular an automobile, with an improved transverse beam, in particular with regard to its shape and its static and dynamic load carrying capacity. In addition, other objects, desirable features and characteristics will become apparent from the subsequent summary and detailed description, and the appended claims, taken in conjunction with the accompanying drawings and this background.

### SUMMARY

According to various aspects, provided is a motor vehicle, in particular an automobile, with an underbody structure, which has a base and two longitudinal beams, spaced apart from one another, connected at least in the front and rear region with the transverse beam, and spring plates to support spiral springs, wherein the transverse beam arranged in the rear region of the chassis is constructed as a hollow profile, the covering wall of which is formed from at least two individual carrier profiles which are connected with one another.

Through the structure of the transverse beam according to the present disclosure, this beam is able to be adapted with regard to its geometric design possibility and also with regard to its dynamic and static load carrying capacity to differing ancillary conditions in the construction and operation of a motor vehicle, in particular an automobile. The hollow-profile structure of the transverse beam alone already gives the latter a distinctly higher torsional stiffness compared with a transverse beam in the manner of a U profile in cross-section, without further components of the chassis, for example, the floor plate of the undercarriage, having to be utilized for its reinforcement. The use, according to the present disclosure, of individual carrier profiles and their connection with one another to the transverse beam enables a distinctly simpler adaptation of the individual carrier profiles to geometric ancillary conditions of the chassis of a motor vehicle, for example, of an automobile. Through its closed-walled covering wall, the transverse beam according to the present disclosure is also able to be integrated simply into the underbody structure of a motor vehicle, for example, an automobile. Steel plate, aluminum plate, but also fiber-reinforced plastics are suitable as materials for the transverse beam according to the present disclosure.

According to one exemplary embodiment of the present disclosure, the covering wall formed by the individual carrier profiles generally defines a cavity which is at least approximately rectangular or at least approximately square in cross-section.

Individual carrier profiles for producing a covering wall defining a square or rectangular cavity are able to be produced and able to be connected with one another in a comparatively favorable manner with regard to manufacture. Furthermore, a transverse beam with a cavity which is rectangular or square in cross-section already has a high modulus of resistance against bending and torsion, so that a chassis, for example, an undercarriage with such a transverse beam, has a high degree of inherent rigidity, at least in the region of the transverse beam. Other cross-sectional shapes are also conceivable for the transverse beam according to the present disclosure.

A generally simple and favorably priced connection of the base to the transverse beam is produced when, according to another exemplary embodiment of the present disclosure, the individual carrier profiles are connected at their connecting sites with the base, for example, to receive the base between one another at the connecting site. When the base section adjoining the transverse beam is received between the individual carrier profiles for its connection with the transverse beam, a generally resilient connection is produced between the base and the transverse beam.

In one example, one of the individual carrier profiles is provided, for example, at its free ends with the spring plate, which is secured in a single piece, for example, in a single material, on the individual carrier profile, and generally has an aperture to receive at least one shock absorber.

Through the fact that one of the individual carrier profiles forms a structural unit with the spring plate, on the one hand the mounting of the spring plate to the chassis suited to large-scale production is facilitated. On the other hand, through the assembly formation of individual carrier profile and spring plate, both the accurately positioned mounting of the spring plate on the chassis and also the positioning of the spring plate to the individual carrier profile are improved, because the assembly is able to be produced in one production step, e.g. in a punching tool, and hence manufacturing tolerance sums resulting from individual production processes are avoided.

Generally, the individual carrier profiles have an at least approximately identical profile cross-section.

According to another exemplary embodiment of the present disclosure, the profile cross-section of the individual carrier profiles is constructed at least approximately in an L-shape. Favorably priced semi-finished products can be brought into use for such individual carrier profiles.

Generally, the individual carrier profiles which are L-shaped in cross-section have at one of their legs an extension, angled from this leg, which extension extends at least approximately parallel to one of the legs.

Through such a measure, the individual carrier profiles are not only able to be connected with one another in a generally simple manner, but also the connecting of the individual carrier profiles to the base of the subassembly is able to be produced generally simply.

In one example, at least one of the two L-shaped individual carrier profiles connected to the hollow profile has a leg arranged horizontally, from which the other leg of the individual carrier profile extends upwards.

Hereby, in a generally simple manner, a difference in height level can be formed on the hollow profile, which serves as a connection site between the leading section of the base in the direction of travel and the base section trailing it. Through the step-like transition, produced with the aid of the hollow profile, between the leading base section in the direction of travel and the base section trailing it, the trailing base section is raised in a generally simple manner in the region of the rear axle to a necessary height dimension in this region.

A generally simple mounting of the spring plate on an L-shaped individual carrier profile is produced when, according to another exemplary embodiment of the present disclosure, the spring plates are arranged in a single piece, for example, in a single material, on the horizontally arranged leg, for example, at its free end.

According to another exemplary embodiment of the present disclosure, the L-shaped individual carrier profiles have legs of unequal lengths. Hereby, a hollow profile is produced which is able to be adapted generally simply, with regard to its cross-section, to different installation conditions of the undercarriage.

In one example, the longer leg at least of one of the L-shaped individual carrier profiles is arranged horizontally with an upwardly projecting shorter leg, and the longer leg, for example, at its free ends, is provided in a single piece, for example, in a single material, with the spring plates.

Through the legs of unequal length of the L-shaped individual carrier profiles, the latter can be connected with one another in a generally simple manner. Also, a comparatively variable shape of the cavity dimension for the hollow profile is possible in a generally simple manner through the use of L-shaped individual carrier profiles with legs of unequal length.

Generally, the L-shaped individual carrier profiles are provided at their shorter leg with the extension, which extends at least approximately parallel to the longer leg of the L-shaped individual carrier profiles.

According to another exemplary embodiment of the present disclosure, one of the L-shaped individual carrier profiles is connected by its extension with the extension or the longer leg of the other L-shaped individual carrier profile to the hollow profile.

According to another exemplary embodiment of the present disclosure, the longer legs of the generally two L-shaped individual carrier profiles are connected with one another, for example, welded, arranged horizontally with an upwardly projecting shorter leg and receiving between them an end section of the base.

Through such a construction of the hollow profile produced from two L-shaped individual carrier profiles with legs of unequal length, the cross-sectional area of the hollow profile, for example, its width, can be varied in a generally simple manner. In addition, a transverse beam constructed by such individual carrier profiles enables a generally favorable gradational transition from the leading base section in the direction of travel of the motor vehicle to the base section trailing it.

In one example, the longer legs of the L-shaped individual carrier profiles are connected with one another, for example, welded, with interposition of the base. Generally, the longer legs of the L-shaped individual carrier profiles are directed by their free end in the direction of travel of the motor vehicle.

Hereby it is achieved in a generally simple manner that the trailing base section in the direction of travel of the motor vehicle is increased in height in a step-like manner with respect to the leading base section, and therefore additional installation space is obtained in the rear axle region.

A person skilled in the art can gather other characteristics and advantages of the disclosure from the following description of exemplary embodiments that refers to the attached drawings, wherein the described exemplary embodiments should not be interpreted in a restrictive sense.

### BRIEF DESCRIPTION OF THE DRAWINGS

The various embodiments will hereinafter be described in conjunction with the following drawing figures, wherein like numerals denote like elements, and wherein:

FIG. 1 is the rearward region of an automobile underbody structure with a transverse beam connecting its two longitudinal beams in stereoscopic view from above;

FIG. 2 is the underbody structure according to FIG. 1 in stereoscopic view from below;

FIG. 3 is in part the underbody structure according to FIG. 1 in the region of the transverse beam, having an upper and a lower individual carrier profile, in sectional representation IV-IV; and

FIG. 4 is the lower individual carrier profile according to FIG. 2 in stereoscopic view from above.

### DETAILED DESCRIPTION

The following detailed description is merely exemplary in nature and is not intended to limit the present disclosure or the application and uses of the present disclosure. Furthermore, there is no intention to be bound by any theory presented in the preceding background or the following detailed description.

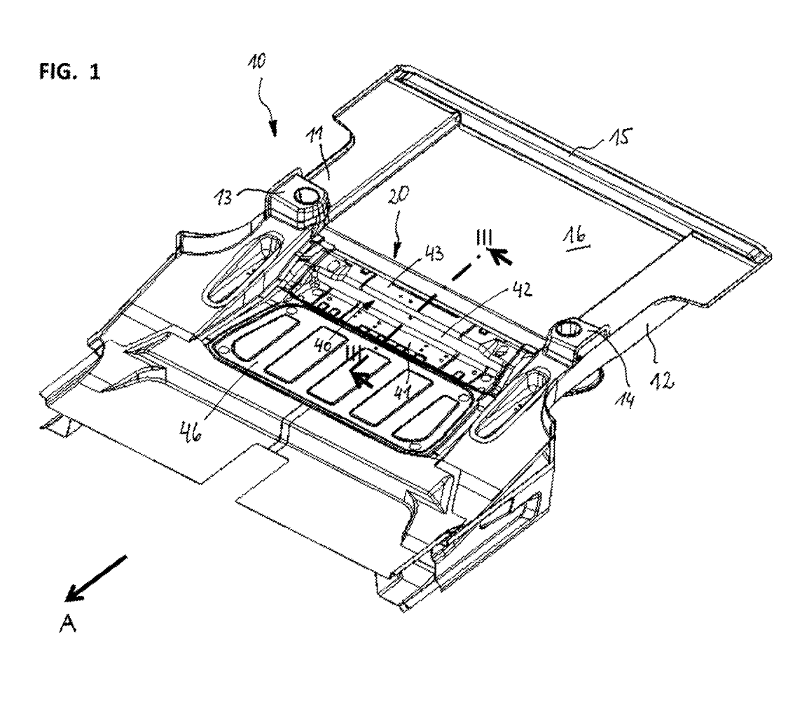

According to FIG. 1, a rear underbody structure 10 for an automobile is shown in simplified diagrammatic representation, which has two longitudinal beams 11 and 12 spaced apart from one another, running on the lateral edges thereof, of which the longitudinal beam 11 running in travel direction A is arranged on the right side and the longitudinal beam 12 is arranged on the left side on the underbody structure 10. In the present example, the longitudinal beams 11 and 12 are constructed as hollow profiles and have on their upper side, at a distance from their free rearward ends, in each case a damper mount 13 or respectively 14, which extends upwards in the manner of a dome from the upper side of the longitudinal beams 11 and 12.

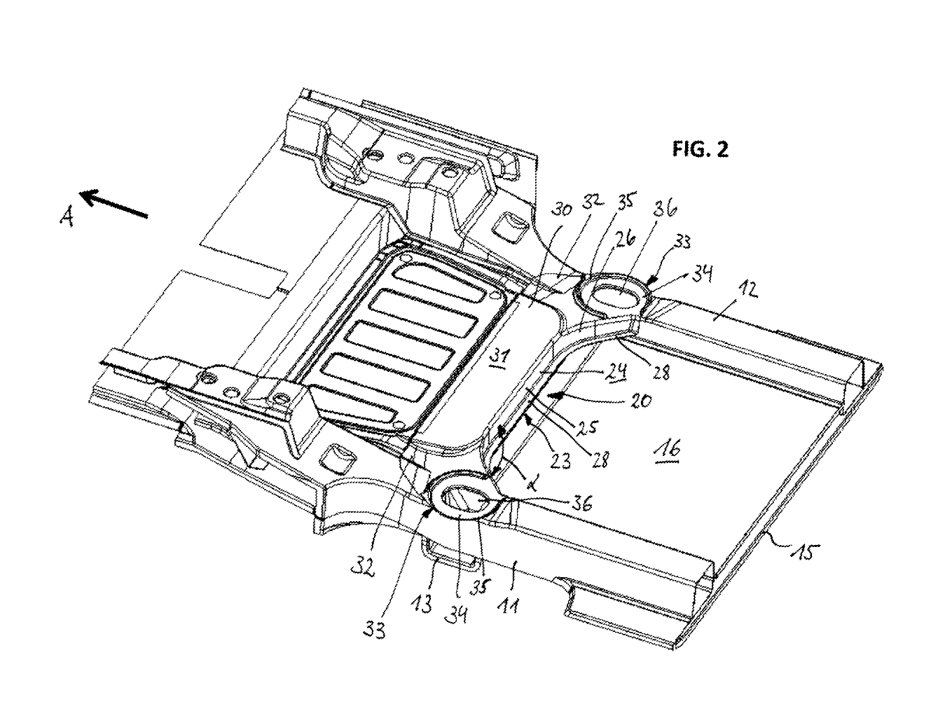

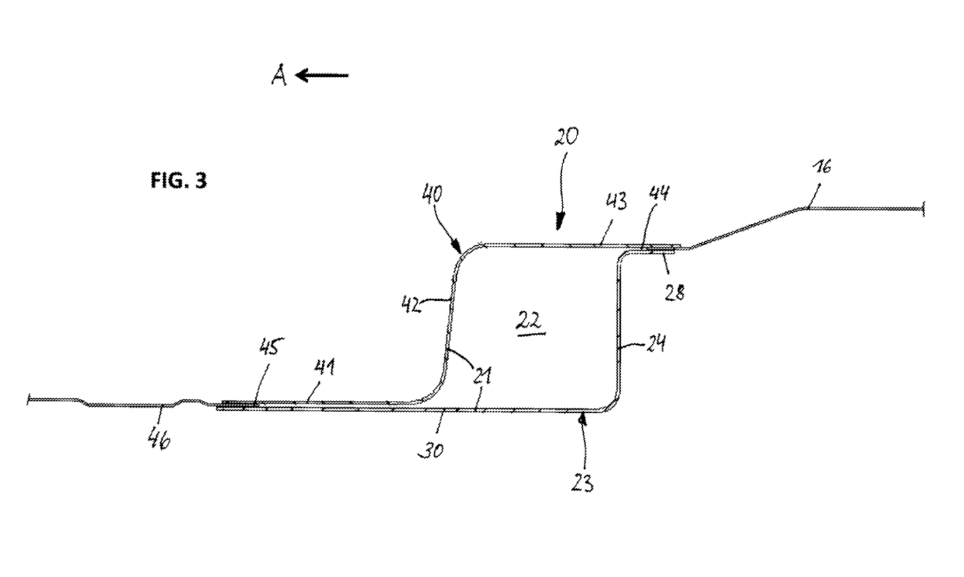

At their free rearward ends, the longitudinal beams 11 and 12 are connected transversely by a rear end beam 15. A rear base section 16 is connected to the rear end beam 15 generally by welding, which base section is secured by its lateral edges on the longitudinal beams 11 and 12 and which is connected, generally by welding, on its side lying opposite the end beam 15 with a transverse beam 20 constructed as a hollow profile (see in this respect also FIG. 2 and FIG. 3).

As FIG. 3 shows in one example, the transverse beam 20, constructed as a hollow profile, having a covering wall 21, which in the present example defines a cavity 22 equipped with a square cross-sectional area. In the present example, the covering wall 21 is formed by two individual carrier profiles which are joined together to form a single-piece composite, of which the individual carrier profile 23 arranged lying lower in the composite has an L-shaped cross-section with legs of unequal length, of which the shorter constructed leg 24 in the installed position is arranged at least approximately vertically into the underbody structure 10.

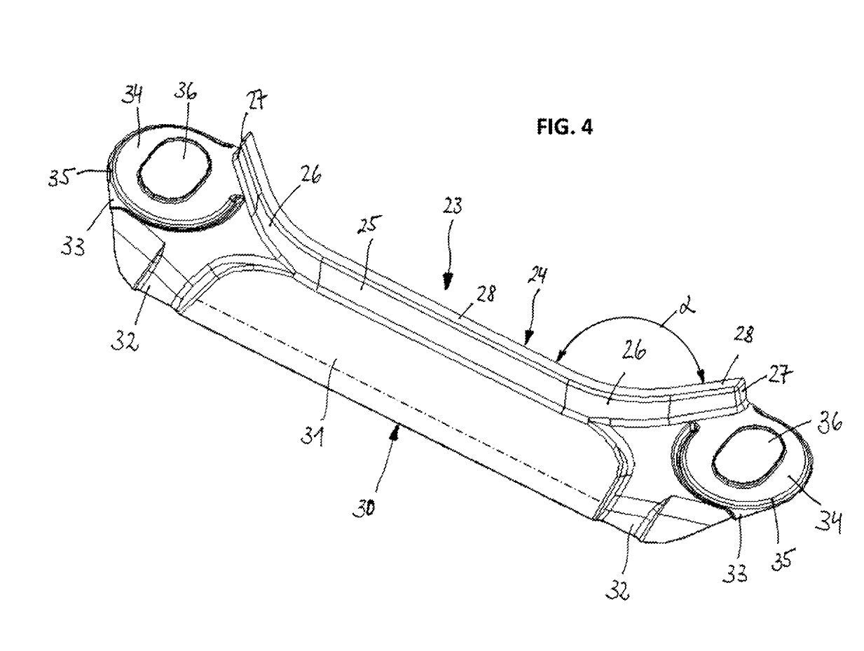

As can be seen with reference to FIG. 4, the individual carrier profile 23 has on its shorter constructed leg 24 a central crosspiece 25, on which holding crosspieces 26 are connected laterally, which, as FIG. 2 also shows, run obliquely toward the rear and form an obtuse intermediate angle α with the central crosspiece. The lateral holding crosspieces 26 are provided with a weld flange 27 at their free end. The holding crosspieces 26, like the central crosspiece 25, are equipped in a single material with an extension 28 produced by angling of the shorter leg 24, which extension extends substantially parallel to a second, longer constructed leg 30 of the individual carrier profile 23 constructed in an L-shape in cross-section, but points with its free end in the direction of the rear base section 16 (see in this respect also FIG. 2 and FIG. 3).

In the present example, the longer leg 30 has a central section 31, shaped in a step-like manner downwards, serving to reinforce it (see in this respect also FIG. 2), adjoining which is a connecting section 32, in the present example constructed as a weld flange, which is formed in a single piece, for example, in a single material, onto the central section 25. Adjacent to the central section 31, the longer leg 30 has lateral support sections 33, arranged vertically offset to the central section 31, into which a circular mount, serving as a spring plate 34, is formed without machining. The spring plates 34 are bordered by an edge crosspiece 35, likewise produced in the present example by non-machining shaping of the longer leg 30, which edge crosspiece serves as a lateral guide for spiral springs, which are not illustrated. The free ends of the edge crosspieces 35 run out at the lateral holding crosspieces 26 and project from the spring plates 34 towards the underside of the central section 31 (see in this respect also FIG. 2). Openings 36, oval-shaped in top view, which serve as through-holes for shock absorbers which are not shown, are introduced into the circular mounts serving as spring plates 34.

As FIG. 3 shows in one example, the individual carrier profile 23 connected in the present example with a second individual carrier profile 40 to the transverse beam 20 which is constructed as a hollow profile. The individual carrier profile 40, like the individual carrier profile 23, is equipped as an L-shaped individual carrier profile with legs 41 and 42 of unequal length, of which the longer leg 41 like the longer leg 30 is arranged horizontally. The shorter leg 42 projects at least substantially vertically upwards from the longer leg 41 and in the present example is provided in a single material with an extension 43, which is constructed longer than the extension 28 and is formed by angling of the shorter leg 42. The extension 43 runs parallel both to the longer leg 30 and also to the extension 28 and forms together therewith a connecting section 44 for the front end section of the rear base section 16. For connection with the transverse beam 20, the rear base section 16 is inserted between the extensions 28 and 43 and is connected therewith for example by welding.

The two longer legs 30 and 41, like the extensions 28 and 43, form a connecting section 45, with which an edge strip of a base section 46 is inserted. This is formed by the end sections of the longer legs 30 and 41, which receive between them the edge strip and are connected therewith in the present case by welding.

As can be seen for example from FIG. 2, the weld flanges 32 of the lower L-shaped individual carrier profile 23 in the installed position are connected with the inner sides of the longitudinal beams 11 and 12. In addition, the support sections 33 of this individual carrier profile 23 are connected with the two longitudinal beams 11 and 12, generally by welding. Through these connections of the transverse beam 20 to the longitudinal beams 11 and 12, and the base sections 16 and 46 secured on the longitudinal beams 11 and 12, the underbody structure is constructed in one example, in the rear axle region into an inherently stable structure. In one example, the structure of the transverse beam 20 contributes to this, through the geometric shape of which, in connection with the spring plates 34 formed into the transverse beam 20, the underbody structure is constructed in the rear axle region in a targeted manner so as to be torsion- and bending-resistant.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the present disclosure in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the present disclosure as set forth in the appended claims and their legal equivalents.

What is claimed is:

1. A motor vehicle, comprising:
a rear underbody structure, which has a base and two longitudinal beams spaced apart from one another, connected with a transverse beam at least in the front and rear region, and spring plates for supporting spiral springs,
wherein at least the transverse beam arranged in the rear region of the underbody structure is constructed as a hollow profile, and a covering wall of the transverse beam is formed from at least two individual carrier profiles which are connected with one another.

2. The motor vehicle according to claim 1, wherein the covering wall formed by the at least two individual carrier profiles defines a cavity which is at least approximately rectangular or at least approximately square in cross-section.

3. The motor vehicle according to one of claim 1, wherein the at least two individual carrier profiles are connected at their connecting sites with the base so as to receive the base between the at least two carrier profiles at the connecting site.

4. The motor vehicle according claims 1, wherein one of the at least two individual carrier profiles is provided at its free end with the spring plate, which is secured in a single piece, in a single material on the selected one of the at least two individual carrier profiles and has an aperture to receive at least one shock absorber.

5. The motor vehicle according to claim 1, wherein the at least two individual carrier profiles have an at least approximately identical profile cross-section.

6. The motor vehicle according to claim 5, wherein the profile cross-section of the at least two individual carrier profiles is constructed at least approximately in an L-shape.

7. The motor vehicle according to claim 6, wherein the at least two individual carrier profiles, which are L-shaped in cross-section, have on one of their legs an extension angled from this leg, which extension extends at least approximately parallel to another one of the legs of the at least two individual carrier profiles.

8. The motor vehicle according to claim 6, wherein the at least two individual carrier profiles are connected to the hollow profile, and at least one of the individual hollow profiles has a horizontally arranged leg, from which the other leg of the at least two individual carrier profiles extends upwards.

9. The motor vehicle according to claim 8, wherein the spring plates are arranged in a single piece, in a single material on the horizontally arranged leg, at its free end.

10. The motor vehicle according to claim 6, wherein the L-shaped individual carrier profiles have legs of unequal length.

11. The motor vehicle according to claim 10, wherein the longer leg at least of one of the at least two individual carrier profiles is arranged horizontally with an upwardly projecting shorter leg, and the longer leg is provided with the spring plates at its free ends in a single piece, in a single material.

12. The motor vehicle according to claim 10, wherein the at least two individual carrier profiles are provided at their shorter leg with an extension, which extends parallel to the longer leg of the at least two individual carrier profiles.

13. The motor vehicle according to claim 7, wherein one of the at least two individual carrier profiles is connected with its extension with the extension or the longer leg of the at least two individual carrier profiles to the hollow profile.

14. The motor vehicle according to claim 10, wherein the hollow profile has longer legs, composed of the at least two individual carrier profiles, that are connected with one another, and arranged horizontally with an upwardly projecting shorter leg and receiving between them an end section of the base.

15. The motor vehicle according to claim 10, wherein the longer legs of the at least two individual carrier profiles are directed by their free end in the travel direction of the motor vehicle.
